(19) United States
(12) Patent Application Publication
(10) Pub. No.: US 2005/0217071 A1
(43) Pub. Date: Oct. 6, 2005

(54) Wheeled packaging

(75) Inventor: Neil Shinner, London (GB)

Correspondence Address: COHEN, PONTANI, LIEBERMAN & PAVANE, Suite 1210, 551 Fifth Avenue, New York, NY, 10176, US

(73) Assignee: Spin Master Limited

(21) Appl. No.: 11/086,886

(22) Filed: Mar. 22, 2005

(30) Foreign Application Priority Data
Mar. 22, 2004 (GB) 0406264.2

(51) Int. Cl. B60B 33/04; B65B 1/00

(52) U.S. Cl. 16/19

(57) ABSTRACT

Disposable packaging with retractable wheels, the wheels movable between an in-use transport position to bear the weight of the packaging and allow movement of the same, and a retracted storage position where the wheels are retained in a non protruding position.

The invention to which this application relates is packaging and storage means which include movement means, and particularly where the packaging has a limited life span and is thereby known as disposable packaging.

Although the following description refers almost exclusively to the implementation of wheels or rollers on disposable packaging, it will be appreciated by persons skilled in the art that features of the present invention can be used on other objects, not limited to packaging, disposable or otherwise, and moreover, other movement means other than wheels may be anticipated in line with the idea behind the invention.

When considering packaging for items at the time of purchase from a retail unit, internet retailer or the like, there is a preference for the packaging to be safe, environmentally friendly and disposable.

Existing packaging for large items tends to be limited to large boxes, which are cumbersome and heavy to carry. Typically such items would be loaded on to a trolley in order to transport the same from a storage facility in a shop to a point of purchase, but is more difficult to transport thereafter, as most people would not have trolleys or equivalent transport means to carry the package from the point of purchase to the transport and from transport to the final destination.

British patent GB 2338221 discloses disposable packaging with wheels, but in this document the wheels add to the volume of the device i.e. they always extend beyond the faces of the packaging, such that the wheels can get caught on objects during transit and the packaging of this form is difficult to stack during the storage and subsequent display of the packages due to the protruding wheels. These problems can be sufficient to cause the packages of this type to be unused commercially.

The aim of the present invention is to provide improved packaging with wheels or rollers, hereinafter referred to in a non-limiting manner as wheels, provided in a form which overcomes the problems hereinbefore described.

In a first aspect of the invention, there is provided packaging with an item or items located therein at least prior to unpacking following purchase of the item by a consumer, said packaging including at least one wheel assembly provided thereon to allow the packaging to be moved across a surface with the at least one wheel in the assembly contacting the surface and wherein said at least one wheel is movable between a transport position and a retracted position and in the retracted position said at least one wheel is located in a non protruding storage position.

In one embodiment, the packaging is disposable thereby having a limited life span.

In one embodiment each wheel includes a central opening for location of an axle and about which the wheel rotates.

Preferably each wheel is connected to a wheel housing, which is pivotally movable with respect to the packaging. In one embodiment the housing is mounted on a casing which is located on the packaging. In one embodiment the portion of the packaging at or adjacent to the location of the wheel assembly is strengthened with respect to the rest of the packaging such as by the provision of an additional layer and/or the provision of additional material.

In one embodiment the packaging is formed of cardboard and is provided as a retail package for an item with the packaging, once the item has been purchased and the item removed, designed to be discardable along with the wheel assemblies mounted thereon.

Preferably the wheel housing is provided with one of a protrusion or a groove or slot and the portion with respect to which the same is pivotally movable is provided with the other of the protrusion or groove and slot for interengagement and control of the pivotal movement.

In one embodiment the wheel is provided in connection with a housing which in turn is connected to a casing to form the wheel assembly and it is the casing which is locatable in a recessed portion of the packaging, typically at a corner thereof. In one embodiment the casing is connectable via location members which pass from the casing into and through the adjacent wall of the packaging.

Typically at a first end of the groove there is defined a storage position, and at the second end an in-use or transit position. In one embodiment the orientation of the packaging for movement and/or the effect of gravity is used in conjunction with the selective positioning of the assembly on the packaging to cause the wheel and/or housing therefore to move from the storage position to the in use position.

In one embodiment biasing means are provided to retain the one or more protrusions or axle in a particular position such as clips, springs, magnets, and the like.

In a further embodiment the ends of the groove are provided with retention formations to cause the wheel or wheel housing to be retained in a particular position.

Preferably the slot or groove includes one or more bends, such that the one or more protrusions is slid around at least one bend when moved between the storage position and the transit position.

In one embodiment, in the storage position, the wheels are retained within the casing and, in turn, within the recess formed in the packaging such that the wheel and/or wheel housing do not extend beyond the planes of the outer surface of the packaging and so allow the packaging to be stored and stacked in the same manner as a normal packaging box. When the one or more protrusions or axle is in a transit position, the wheels are moved to a position where they protrude from the box and engage the surface, such that they provide support for the box and the box is thereby moveable using the same.

Preferably the wheel housing includes a grip member to assist the user in moving the wheels from a storage position to a transit position. In one embodiment the grip member also acts as a masking means for the wheel when in the storage position thus preventing the ingress of debris or indeed damage to the wheel itself during normal storage and transit.

Preferably the weight of the packaging helps to retain the wheel in a particular position between an end of the slot or groove, and a bend.

In one embodiment each wheel is provided with its own axle such that the axle need not pass through the packaging itself and so the provision of the wheel assemblies does not reduce the storage space available within the packaging itself.

In this embodiment, each wheel axle is provided on the wheel housing of the assembly and it is the casing of the assembly which is attached to the packaging.

In a second aspect of the invention, there is provided a wheel assembly, said wheel assembly including an outer casing, said casing having a face or faces for placement on the item on which the wheel assembly is to be used, a housing which is pivotally movable with respect to the casing and a wheel which is rotatably mounted in said housing and movable therewith between an in use position and retracted position where the wheel lies within a volume defined by the casing.

Specific embodiments of the invention are now described wherein:

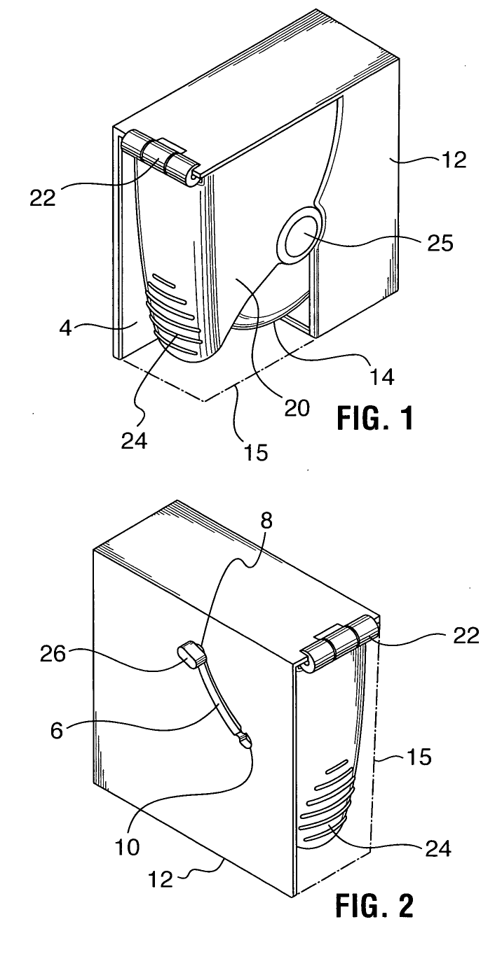

FIG. 1 illustrates a perspective view of a wheel assembly in a first embodiment in a storage position;

FIG. 2 illustrates a further perspective view of the wheel assembly of FIG. 1;

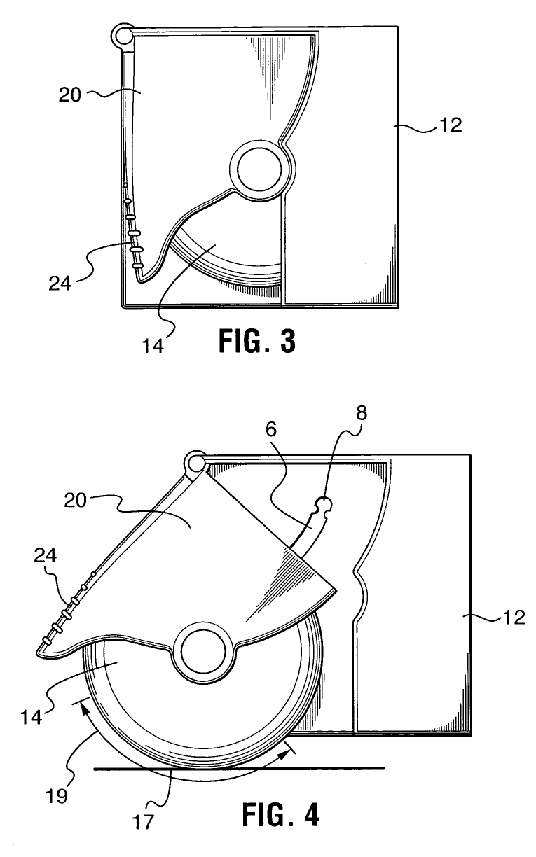

FIG. 3 illustrates a side view of the wheel assembly of FIG. 1;

FIG. 4 illustrates a side view of the wheel assembly of FIGS. 1-3 with the wheel assembly in the in use transport position.

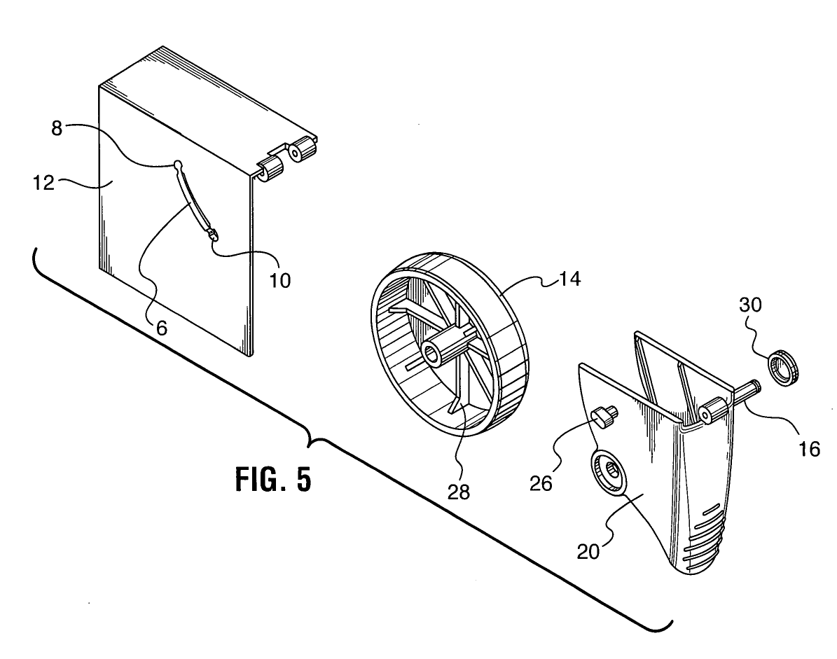

FIG. 5 illustrates an exploded perspective view of the wheel assembly of FIGS. 1-4 for packaging.

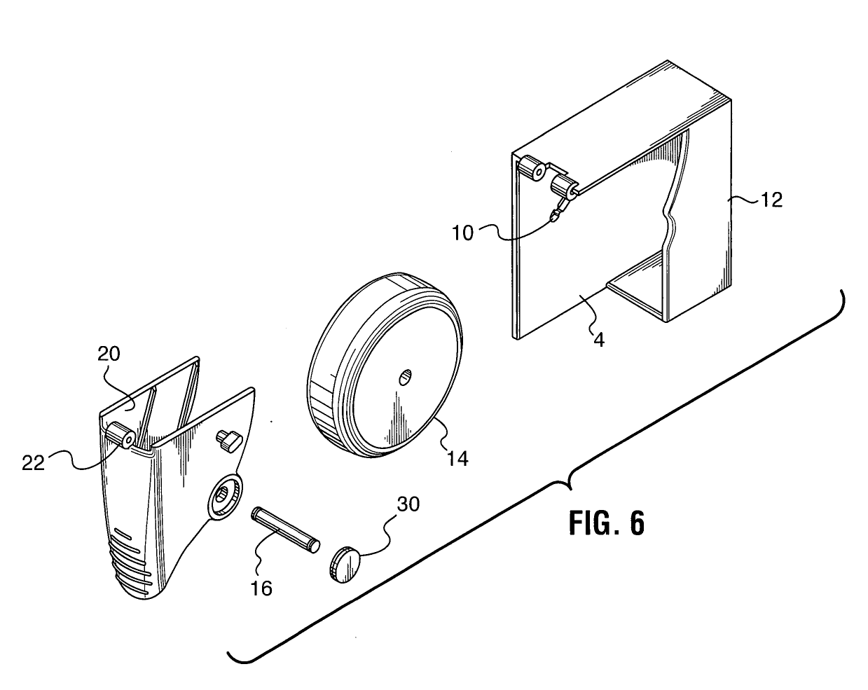

FIG. 6 illustrates a further exploded perspective view of a wheel assembly for packaging.

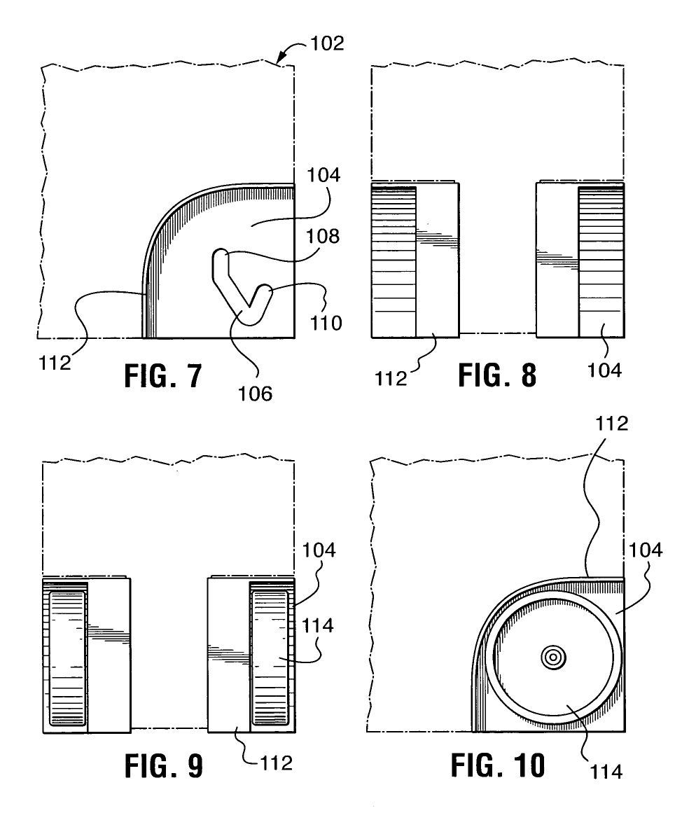

FIG. 7 illustrates a side view of packaging with a wheel casing of a second embodiment attached thereto with the wheels removed.

FIG. 8 illustrates a rear view of packaging with the wheels removed.

FIG. 9 illustrates a rear view of packaging with wheel assemblies of the second embodiments in a storage position.

FIG. 10 illustrates a side view of packaging with the wheel assembly of the second embodiment in a storage position.

FIG. 11 illustrates a perspective view of packaging with the wheel assembly of the second embodiment in a storage position.

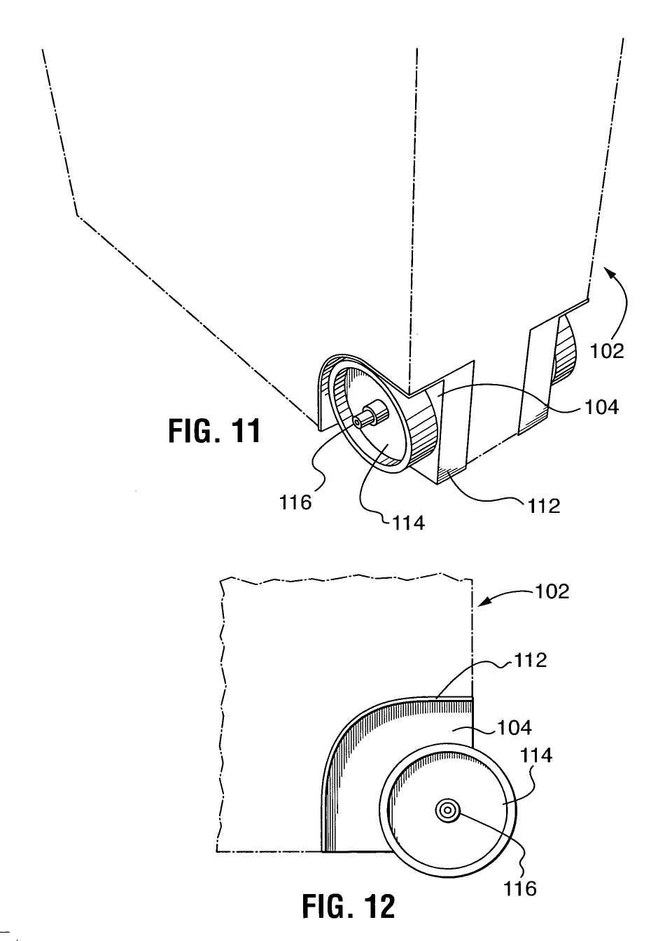

FIG. 12 illustrates a side view of packaging with the wheel assembly of the second embodiment in a transport position; and

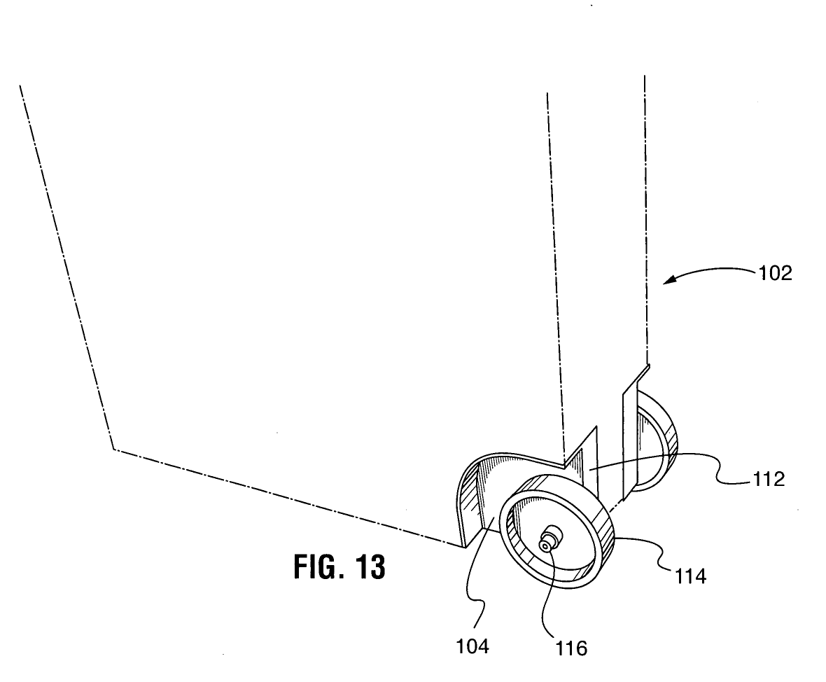

FIG. 13 illustrates a perspective view of the packaging with the wheel assembly in a transport position.

With reference to FIGS. 1-2, there is illustrated a preferred embodiment of a wheel assembly for packaging, including a support or casing 12 with an open recess portion 4. A wheel housing or support 20 is pivotally mounted on the support casing 12 by pivot 22 and a wheel 14 is rotationally mounted on the wheel support 20 via an axle 25. The wheel support 20 also includes a grip 24 to allow the user to move the wheel support 20 more easily. The wheel support 20 includes a protrusion 26 which engages a groove or slot 6 on the support 12. A first end 8 of the groove or slot 6 is for the location of the protrusion 26 when the wheel 14 is in the stored position, the second end 10 of the groove or slot 6 is for the location of the protrusion 26 when the wheel 14 is in the transport position. The groove or slot 6 is pinched towards each end to define notches to help retain the protrusion 26 at a particular end.

Referring to FIGS. 1-3, there is illustrated a wheel assembly for packaging with the wheel in the storage position and it is clear that the wheel 14 does not protrude beyond the planes defined by the faces of the rectangular volume defined by the planes of the faces of the support 12 and shown in broken lines. In this storage position the protrusion 26 is located at the first end 8 of the groove or slot 6.

Referring to FIG. 4, there is illustrated the wheel assembly for packaging with the wheel in the transport position such that the wheel 14 protrudes beyond the edges of the support 12. The wheel 14 engages a surface 17 which is tangential at any angle to the floor portion 19 of the wheel and provides support to the support 12 when placed on the surface. The protrusion 26 is located at the second end 10 of the groove or slot 6. The weight borne by the wheel 14 may help to retain the wheel 14 in this position. Packaging fitted with such wheel assemblies can therefore be moved around easily, with the wheels providing support and allowing movement.

Referring to FIGS. 5-6, further detail of the wheel assembly components is indicated. The wheel 14 may have spokes 28 to provide structural strength to the same. The wheel 14 is mounted on the axle 16, which is mounted between opposite sides of the wheel support 20. Caps 30 are provided to cover and protect the ends of the axle 16.

With reference to FIG. 7, there is illustrated a box 102 including wheel assemblies of a different embodiment to that of FIGS. 1-6 although the same operating principles apply. A support 112 is located in one corner of the box 102. The support 112 includes a recess 104 on either side of the box 102. The recess 104 includes a groove or slot 106 for the location of the wheel axle. The groove or slot 106 has two or more bends. A first end 108 of the groove or slot 106 is for the location of the axle when the wheel is in the stored position, the second end 110 of the groove or slot 106 is for the location of the axle when the wheel is in the transport position.

Referring to FIGS. 8-10, the size of the recess 104 is illustrated with respect to the support 112 and wheels 114.

With reference to FIG. 11, there is illustrated a box 102 including wheels 114 mounted on an axle 116, the axle 116 engaging support 112. The wheels 114 are in a storage position and recessed in recess 104 such that they do not provide support to the box 102 by engaging a surface when the box 102 is placed on the surface.

With reference to FIGS. 12-13, the wheels 114 are shown in a transport position, the axle 116 having moved along the groove or slot (not shown) and thereby extending the wheels from the recess 104 such that they provide support to the box 102 by engaging a surface when the box 102 is placed on the surface.

Referring to FIG. 13, support is provided by the wheels 114 to one side of the box, and by the surface at the opposite side. By lifting the opposite side and pivoting the box 102 around the wheel axle 116, at least part of the weight of the box 102 can be borne by the wheels 114, allowing the box 102 to be moved easily from one location to another.

It will be appreciated by persons skilled in the art that the present invention also includes further additional modifications made to the device which does not effect the overall functioning of the device, such as the provision of decoration, a fabric or plastic covering to provide improved aesthetic appearance, and/or the like.

1. Packaging for locating one or more items therein, said packaging including movement means provided thereon, said movement means being movable between a transport position and a storage position, said movement means in said transport position allowing the packaging to be moved across a surface, characterised in that in the storage position said movement means is located in a non protruding storage position.

2. Packaging according to claim 1, characterised in that said packaging is disposable and/or has a limited lifespan.

3. Packaging according to claim 2, characterised in that said packaging is made of cardboard.

4. Packaging according to claim 1, characterised in that said movement means is any or any combination of wheels, rollers, and/or the like.

5. Packaging according to claim 1, characterised in that said movement means is rotationally mounted on one or more axles.

6. Packaging according to claim 1, characterised in that said movement means includes a housing.

7. Packaging according to claim 6, characterised in that said movement means and/or housing is pivotally movable with respect to the packaging.

8. Packaging according to claim 6, characterised in that said housing includes one or more grip members to aid grip of the housing.

9. Packaging according to claim 7, characterised in that the movement of the movement means and/or housing between a storage position and a transport position is influenced by the orientation of the packaging and/or gravity.

10. Packaging according to claim 7, characterised in that said movement means and/or housing is pivotally mounted on a casing located on the packaging.

11. Packaging according to claim 10, characterised in that said casing includes locating members which pass from the casing into and/or through the adjacent wall of the packaging.

12. Packaging according to claim 1, characterised in that one or more portions of said packaging at or adjacent the movement means are strengthened with respect to the rest of the packaging.

13. Packaging according to claim 10, characterised in that said movement means, housing, and/or casing are provided with male engagement means and/or female engagement means.

14. Packaging according to claim 13, characterised in that a storage position is defined by the male engagement means engaging a first end of the female engagement mean.

15. Packaging according to claim 13, characterised in that a transport position is defined by the male engagement means engaging a second end of the female engagement mean.

16. Packaging according to claim 13, characterised in that said male engagement means are any or any combination of protrusions, knobs, axles, and/or the like.

17. Packaging according to claim 13, characterised in that said female engagement means are any or any combination of grooves, slots, recesses, and/or the like.

18. Packaging according to claim 13, characterised in that the engagement of said male and female engagement means allows the pivotal movement of the movement means and/or housing with respect to the casing to be controlled.

19. Packaging according to claim 13, characterised in that said movement means, housing, and/or engagement means include biasing means to bias the same into a transport position and/or a storage position.

20. Packaging according to claim 19, characterised in that said biasing means includes any or any combination of clips, springs, magnets, gravity, and/or the like.

21. Packaging according to claim 13, characterised in that said female engagement means include retention means to retain the same in a transport position and/or a storage position.

22. Packaging according to claim 21, characterised in that said retention means includes any or any combination of clips, magnets, grooves, slots, recesses, gravity, and/or the like.

23. Packaging according to claim 13, characterised in that said female engagement means includes one or more bends, such that the male engagement means is moved around at least one bend when moved between a storage position and a transit position.

24. A wheel assembly, said wheel assembly including an outer casing, said casing having a face or faces for placement on the item on which the wheel assembly is to be used, a housing which is pivotally movable with respect to the casing and a wheel which is rotatably mounted in said housing and movable therewith between an in use position and retracted position characterised in that the retracted position the wheel lies within a volume defined by the casing.
